(19) United States
(12) Patent Application Publication
(10) Pub. No.: US 2018/0258226 A1
(43) Pub. Date: Sep. 13, 2018

(54) METHOD FOR PRODUCING OR CURING POLYMERS USING THIOL-ENE POLYADDITION REACTIONS

(71) Applicants: Henkel AG & Co. KGaA, Duesseldorf (DE); Max-Planck-Gesellschaft Zur Foerderung Der ..., Muenchen (DE)

(72) Inventors: Andreas Taden, Duesseldorf (DE); Stefan Kirschbaum, Leverkusen (DE); Katharina Landfester, Mainz (DE)

(21) Appl. No.: 15/977,184

(22) Filed: May 11, 2018

Related U.S. Application Data
(63) Continuation of application No. PCT/EP2016/077207, filed on Nov. 10, 2016.

(30) Foreign Application Priority Data
Nov. 11, 2015 (EP) 15194064.0

(51) Int. Cl. C08G 75/045

(52) U.S. Cl. CPC C08G 75/045

(57) ABSTRACT

The invention relates to a method for producing polymers, particularly polyhydroxyurethanes (PHU) from alkenyl ether polyols or pre-polymers that contain monomer units derived from such alkenyl ether polyols, and polythiol compounds, as well as to a method for crosslinking compounds containing alkenyl ether groups, with polythiol compounds. The invention also relates to the polymers and crosslinked polymers that can be obtained using the method according to the invention.

The present invention relates to a method for producing polymers, in particular polyhydroxyurethanes (PHU), from alkenyl ether polyols or prepolymers that contain monomer units derived from such alkenyl ether polyols, and polythiol compounds, and to a method for crosslinking alkenyl ether group-containing compounds with polythiol compounds. The invention also relates to the polymers and crosslinked polymers that can be obtained using the method according to the invention.

Photopolymers are the subject of growing interest since they can be used in a wide variety of important fields of technology, for example stereolithography, nanoimprint lithography, 3D printing, and energy-saving LEDs, which are suitable for causing correspondingly adapted photopolymer systems to react, are also available. Photopolymerization generally requires low amounts of energy and is increasingly used in the field of adhesives and coatings as a replacement for environmentally harmful solvent-based product formulations and processes. There is therefore a general interest in replacing existing production and curing methods with alternatives that are based on photopolymerization.

Polyhydroxyurethanes, i.e. polyurethanes having a plurality of free hydroxy groups per molecule, are currently mainly produced by the aminolysis of cyclic carbonates. Although this synthesis pathway is environmentally friendly since the use of isocyanates and phosgene can be dispensed with, only polyurethanes having comparatively low molecular weights can be additionally obtained if thermoplastic polymer systems are desired (i.e. uncrosslinked and largely unbranched, linear polymer chains).

There is therefore the need for an improved (in comparison with the prior art) method for producing polyhydroxyurethanes (PHUs), which method allows high-molecular polymers to be obtained, but is still environmentally friendly insofar as the use of isocyanates and phosgene can be dispensed with.

It has now been found that PHUs and also other hydroxyl group-containing polymers can alternatively be obtained by thiol-ene click polyaddition using alkenyl ether polyols. Alkenyl ether-functionalized polyols are generally excellent precursors for numerous UV-initiated cationic polycondensation and polyaddition reactions and, depending on the structure and degree of functionalization, allow good control of the crosslink density in the resulting polymer systems. Alkenyl ether polyols can be used very generally as starting materials for the synthesis of oligomers and polymers, which are obtainable by means of the reaction of the OH groups, for example polyaddition processes or polycondensation reactions. Polymers that can be obtained in this manner include polyesters, polyethers, polyurethanes and polyureas, for example. The alkenyl ether functionalities allow additional functionalization, crosslinking and polymerization reactions, for example cationic polymerization or even radical copolymerization, of the polyols and the reaction products thereof.

A first subject of the present invention is therefore a method for producing a polymer, in particular a polyhydroxyurethane polymer, comprising reacting at least one alkenyl ether polyol containing at least one alkenyl ether group, in particular a 1-alkenyl ether group, and at least two hydroxyl groups (—OH), or a prepcilymer, which contains at least one such alkenyl ether polyol as a monomer unit, with a compound that contains at least two thiol groups (—SH).

In addition, the invention is directed to a method for crosslinking a compound that contains at least one alkenyl ether group, preferably an alkenyl ether polyol containing at least one alkenyl ether group, in particular a 1-alkenyl ether group, and at least two hydroxyl groups (—OH), or a polymer that contains at least one such alkenyl ether polyol as a monomer unit, in particular a polyurethane or polyester, comprising reacting the compound with a compound that contains at least two thiol groups.

The present invention is further directed to polymers, in particular polyhydroxyerethanes (PUHs), or crosslinked polymers that can be obtained by a method according to the present invention.

“Alkenyl ether polyol”, as used herein, denotes compounds that contain at least one group of the formula —O-alkenyl, which is bonded to a carbon atom, and at least two hydroxyl groups (—OH). It is preferable for the alkenyl ether polyol to comprise an optionally urethane group-containing organic group, to which both the alkenyl ether group and the hydroxy groups are bonded, i.e. the hydroxy groups are not bonded to the alkenyl group. It is further preferable for the alkenyl ether group to be a 1-alkenyl ether group, i.e. there is a C—C double bond adjacent to the oxygen atom. Vinyl ether groups, i.e. groups of the formula —O—CH═CH₂, are very particularly preferred.

The term “urethane group”, as used herein, denotes groups of the formula —O—C(O)—NH— or —NH—C(O)—O—.

The term “alkyl”, as used herein, denotes a linear or branched, unsubstituted or substituted saturated hydrocarbon group, in particular groups of the formula CₙH₂ₙ₊₁. Examples of alkyl groups include, without being limited to, methyl, ethyl, n-propyl, iso-propyl, n-butyl, 2-butyl, tert-butyl, n-pentyl, n-hexyl and the like. “Heteroalkyl”, as used herein, denotes alkyl groups in which at least one carbon atom is replaced by a heteroatom, such as in particular oxygen, nitrogen or sulfur. Examples include, without limitation, ether and polyether, for example diethyl ether or polyethylene oxide.

The term “alkenyl”, as used herein, denotes a linear or branched, unsubstituted or substituted hydrocarbon group that contains at least one C—C double bond.

“Substituted”, as used herein in particular in connection with alkyl and heteroalkyl groups, refers to compounds in which one or more carbon atoms and/or hydrogen atoms are replaced by other atoms or groups. Suitable substituents include, without being limited to, —OH, —NH₂, —NO₂, —CN, —OCN, —SCN, —NCO, —NCS, —SH, —SO₃H, —SO₂H, —COOH, —CHO and the like.

The term “organic group”, as used herein, refers to any organic group that contains carbon atoms. Organic groups can be derived in particular from hydrocarbons, it being possible for any carbon and hydrogen atoms to be replaced by other atoms or groups. Organic groups within the meaning of the invention contain, in different embodiments, 1 to 1,000 carbon atoms.

“Epoxide”, as used herein, denotes compounds that contain an epoxide group.

“Cyclic carbonate”, as used herein, denotes annular compounds that contain the group —O—C(═O)—O— as the ring component.

The term “alcohol” denotes an organic compound that contains at least one hydroxyl group (—OH).

The term “amine” denotes an organic compound that comprises at least one primary or secondary amino group (—NH₂, —NHR).

The term “thiol” or “mercaptan” denotes an organic compound that contains at least one thiol group (—SH).

The term “carboxylic acid” denotes a compound that contains at least one carboxyl group (—C(═O)OH).

The term “derivative”, as used herein, denotes a chemical compound that is modified with respect to a reference compound by one or more chemical reactions. In connection with the functional groups —OH, —COOH, —SH and —NH₂ or the compound classes of the alcohols, carboxylic acids, thiols and amines, the term “derivative” comprises in particular the corresponding ionic groups/compounds and the salts thereof, i.e. alcoholates, carboxylates, thiolates and compounds that contain quaternary nitrogen atoms. In connection with the cyclic carbonates, the term “derivative” can also comprise more specifically described thio derivatives of the carbonates, i.e. compounds in which one, two or all three oxygen atoms of the grouping —O—C(═O)—O— are replaced by sulfur atoms.

“At least”, as used herein in connection with a numerical value, refers to precisely this numerical value or more. “At least one” thus means 1 or more, i.e. 2, 3, 4, 5, 6, 7, 8, 9, 10 or more, for example. In connection with a type of compound, the term does not refer to the absolute number of molecules, but rather to the number of types of substances that come under the particular generic term. “At least one epoxide” thus means that at least one type of epoxide, but also a plurality of different epoxides, may be contained, for example.

The term “curable”, as used herein, denotes a change in the state and/or the structure in a material by chemical reaction, which change is usually, but not necessarily, induced by at least one variable such as time, temperature, moisture, radiation, presence and quantity of a curing catalyst or accelerator and the like. The term relates to both the complete and the partial curing of the material.

“Radiation curable” or “radiation crosslinkable”, thus denotes compounds that, when exposed to radiation, chemically react and form new bonds (intra- or intermolecular).

“Radiation”, as used herein, refers to electromagnetic radiation, in particular UV light and visible light, and to electron radiation. Curing preferably takes place by exposure to light, for example UV light or visible light.

The term “divalent”, as used herein in connection with groups, denotes a group that has at least two connection points, which produce a connection to additional moieties. Within the meaning of the present invention, a divalent alkyl group thus means a group of the formula -alkyl-. A divalent alkyl group of this kind is also referred to herein as an alkylenyl group. “Polyvalent” accordingly means that a group has more than one connection point. For example, a group of this kind may be tri-, tetra-, penta- or hexavalent. “At least divalent” thus means divalent or higher-valent.

The term “poly-” refers to a repeating unit of a (functional) group or structural unit following this prefix. A polyol thus denotes a compound having at least 2 hydroxy groups and a polyalkylene glycol denotes a polymer of alkylene glycol monomer units.

“Polyisocyanate”, as used herein, refers to organic compounds that contain more than one isocyanate group (—NCO).

Unless indicated otherwise, the molecular weights indicated in the present text refer to the number average of the molecular weight (Mₙ). The number average molecular weight can be determined on the basis of an end group analysis (OH number according to DIN 53240; NCO content as determined by titration according to Spiegelberger in accordance with EN ISO 11909) or by gel permeation chromatography according to DIN 55672-1:2007-08 with THF as the eluent. Except where indicated otherwise, all listed molecular weights are those that have been determined by means of end group analysis.

The alkenyl ethers may be aliphatic compounds that contain, in addition to the alkenyl ether group(s), at least one other functional group that is reactive to epoxy or cyclocarbonate groups, including —OH, —COOH, —SH, —NH₂ and derivatives thereof. The functional groups nucleophilically attack the cyclic carbon of the epoxide ring or the carbonyl carbon atom of the cyclocarbonate, the ring opening and a hydroxyl group being formed. Depending on the reactive, nucleophilic group, an O—C—, N—C, S—C, or O—/N—/S—C(═O)O bond is formed in this case.

Alkenyl ether polyol can be produced by two alternative routes A) and B), for example.

In route A), an alkenyl ether, which contains at least one alkenyl ether group and at least one functional group selected from —OH, —COOH, —SH, —NH₂ and derivatives thereof, is reacted with (i) an epoxide or (ii) a cyclic carbonate or derivative thereof.

In route B), an alkenyl ether, which contains at least one alkenyl ether group and at least one functional group selected from (i) epoxide groups and (ii) cyclic carbonate groups or derivatives thereof, is reacted with an alcohol, thiol, a carboxylic acid, or an amine or derivatives thereof. The above-mentioned alcohols, thiols, carboxylic acids and amines may be mono- or polyfunctional.

Irrespective of the route, the alkenyl ether polyols are formed by reacting the hydroxy-, thiol-, carboxyl- or amino groups with an epoxide or cyclic carbonate group by ring opening.

In all embodiments, the reaction partners are selected such that the reaction product, i.e. the obtained alkenyl ether polyol, carries at least two hydroxyl groups.

For example, the alkenyl ether polyol is produced by reacting an alkenyl ether, containing at least one alkenyl ether group and at least one functional group selected from —OH, —COOH, —SH, —NH₂ and derivatives thereof, with (i) an epoxide or (ii) a cyclic carbonate or derivative thereof, the alkenyl ether polyol produced in this way being an alkenyl ether polyol of formula (I)

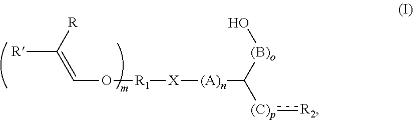

In the compounds of formula (I)
R₁ is an at least divalent organic group, optionally having 1 to 1,000 carbon atoms, in particular an at least divalent linear or branched, substituted or unsubstituted alkyl having 1 to 50, preferably 1 to 20 carbon atoms, or an at least divalent linear or branched, substituted or unsubstituted heteroalkyl having 1 to 50, preferably 1 to 20 carbon atoms, and at least one oxygen or nitrogen atom, R₂ is an organic group, optionally comprising at least one —OH group and/or 1 to 1,000 carbon atoms, in particular an (optionally divalent or polyvalent) linear or branched, substituted or unsubstituted alkyl having 1 to 50, preferably 1 to 20 carbon atoms or an (optionally divalent or polyvalent) linear or branched, substituted or unsubstituted heteroalkyl having 1 to 50, preferably 1 to 20 carbon atoms and at least one oxygen or nitrogen atom. However, R₂ may also be a high-molecular group such as a polyalkylene glycol group. A (poly)alkylene glycol group of this kind may have the formula —O—[CHRₐCH₂O]_{b}—R_{b}, for example, where Rₐ is H or a C₁₋₄ alkyl group, R_{b} is —H or an organic group and b is from 1 to 100.

In the compounds of formula (I), X is O, S, C(═O)O, OC(═O)O, C(═O)OC(═O)O, NRₓ, NRₓC(═O)O, NRₓC(═O)NRₓ or OC(═O)NRₓ. In preferred embodiments, X is O, OC(═O)O, NRₓ or NRₓC(═O)O.

Each R and R′ is selected independently from H, C₁₋₂₀ alkyl and C₂₋₂₀ alkenyl, in particular one of R and R′ being H and the other being C₁₋₄ alkyl or both R and R′ being H. Particularly preferably, R is H and R′ is H or —CH₃.

Each A, B and C is selected independently from carbon-containing groups of formula CR″R′″, where R″ and R′″ are selected independently from H, a functional group, for example —OH, —NH₂, —NO₂, —CN, —OCN, —SCN, —NCO, —NCS, —SH, —SO₃H or —SO₂H, and an organic group. In particular, R″ and R′″ are independently H or C₁₋₂₀ alkyl. However, R″ and R′″ together or together with the carbon atom to which they are bonded may also form an organic group, including cyclic groups, or a functional group. Examples of groups of this kind are ═CH₂, ═CH-alkyl or ═C(alkyl)₂, ═O, ═S, —(CH₂)ₐₐ- where aa=3 to 5, or derivatives of any of these groups, in which one or more methylene groups are replaced by heteroatoms such as N, O or S. However, two of R″ and R′″, which are bonded to adjacent carbon atoms, may also together form a bond. As a result, a double bond is formed between the two adjacent carbon atoms (i.e. —C(R″)═C(R″)—).
[symbol] denotes a single or double bond. When it denotes a double bond, the carbon atom that is bonded to R₂ carries only one substituent R″ or R′″.

In the compounds of formula (I), m is an integer of from 1 to 10, preferably 1 or 2, particularly preferably 1. i.e., the compounds preferably carry only one or two alkenyl ether group(s).

n, p and o are each 0 or an integer of from 1 to 10. In this case, they meet the condition n+p+o=1 or more, in particular 1 or 2. It is particularly preferred that n or o is 1 and the other is 0. Alternatively, it is particularly preferred that n or o is 2 and the other is 0. It is also preferred that p is 0 and one of n and o is 1 or 2 and the other is 0. Embodiments in which n and o are 1 and p is 0 are also preferred.

Rₓ is H, an organic group or

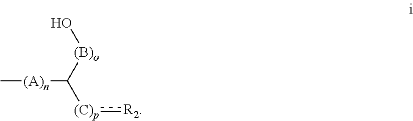

For the alkenyl ether polyol to comprise at least two hydroxyl groups, the compound of formula (I) thus also meets the condition that, when Rₓ is not

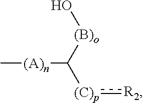

R₂ comprises at least one substituent that is selected from —OH and

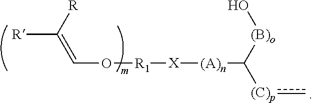

The second hydroxyl group of the compound of formula (I) is therefore either contained in the organic group R₂ as a substituent, or X contains another group of formula

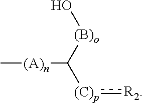

In various embodiments, the alkenyl ether polyol of formula (I) contains at least one urethane group. By means of the reaction with polythiols according to the method described herein, polyhydroxyurethanes (PHUs) can then be obtained.

In various embodiments of the described production method for obtaining an alkenyl ether polyol, the alkenyl ether, which contains at least one alkenyl ether group and at least one functional group selected from —OH, —COOH, —SH, —NH₂ and derivatives thereof, is an alkenyl ether of formula (II).

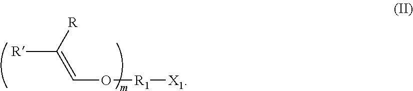

An alkenyl ether of this kind can be used, for example, in order to synthesize an alkenyl ether polyol of formula (I) by reacting it with an epoxide or a cyclic carbonate.

In the compounds of formula (II), R₁, R, R′ and m are as defined above for formula (I). In particular, the preferred embodiments of R₁, R, R′ and m, described above for the compounds of formula (I), may similarly be transferred to the compounds of formula (II).

In the compounds of formula (II)

X₁ is a functional group selected from —OH, —COOH, —SH, —NHR_{y} and derivatives thereof, and
R_{y} is H or an organic group, preferably H.

The derivatives of the functional groups —OH, —COOH, —SH, —NHR_{y} are preferably the ionic variants that are already described above in connection with the definition of the term and are formed by removing or binding a proton, in this case in particular the alcoholates, thiolates and carboxylates, more particularly preferred the alcoholates.

Particularly preferably, X₁ is —OH or —O⁻ or —NH₂.

One embodiment of the described method for producing the alkenyl ether polyol is further characterized in that, in the alkenyl ether of formula (II), m is 1, X₁ is —OH or —NH₂, preferably —OH, R₁ is a divalent, linear or branched C₁₋₁₀ alkyl group (alkylenyl group), in particular ethylenyl, propylenyl, butylenyl, pentylenyl or hexylenyl, and one of R and R′ is H and the other is H or —CH₃.

The alkenyl ethers that may be used in the context of the described method for producing the alkenyl ether polyols, in particular those of formula (II), may be, for example, reaction products of various optionally substituted alkanols (monoalcohols and polyols) with acetylene. Specific examples include, without being limited to, 4-hydroxybutyl vinyl ether (HBVE) and 3-aminopropyl vinyl ether (APVE).

Another embodiment of the described method for producing the alkenyl ether polyols is characterized in that the epoxide that is reacted with the alkenyl ether is an epoxide of formula (III) or (IIIa)

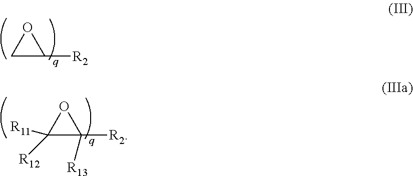

In the compounds of formula (III) and (IIIa), R₂ is as defined above for formula (I).

R₁₁, R₁₂ and R₁₃ are, independently of one another, H or an organic group, optionally having at least one —OH group, in particular a linear or branched, substituted or unsubstituted alkyl having 1 to 20 carbon atoms or linear or branched, substituted or unsubstituted heteroalkyl having 1 to 20 carbon atoms and at least one oxygen or nitrogen atom.

q is an integer of from 1 to 10, preferably 1 or 2.

Epoxy compounds that can be used in the method for producing alkenyl ether polyols are accordingly preferably linear or branched, substituted or unsubstituted alkanes having a number of carbon atoms of from 1 to 1,000, preferably 1 to 50 or 1 to 20, that carry at least one epoxy group. Said epoxy compounds may optionally additionally carry one or more hydroxy groups, as a result of which the degree of hydroxyl functionalization of the alkenyl ether polyol, which results from the reaction of an alkenyl ether that is reactive to epoxides, as described above, with an epoxide, is high. As a result, in subsequent polymerization reactions, the crosslinking density of the desired polymer can in turn be checked and controlled.

In the reaction of an alkenyl ether compound (alkenyl ether having at least one functional group selected from —OH, —COON, —SH, —NH₂ and derivatives thereof) that is reactive to epoxides, an alcohol is formed by ring opening of the epoxide. In the course of the bond formation, the alcoholic group is thus “regenerated” from the reaction of a first alcohol or a compound (amine, thiol, carboxylic acid, etc.) that is chemically related in this context with an epoxide.

In various embodiments, the epoxy compound can carry more than one epoxy group. This allows the reaction of an epoxy compound of this kind with more than one alkenyl ether compound that is reactive to epoxides, for example an amino alkenyl ether or hydroxy alkenyl ether.

In particularly preferred embodiments, the epoxide is an epoxide of formula (III), where q is 1 or 2 and, when q is 2, R₂ is —CH₂—O—C₁₋₁₀-alkylenyl-O—CH₂— and, when q is 1, R₂ is —CH₂—O—C₁₋₁₀-alkyl.

Examples of epoxy compounds that can be used in the method for producing alkenyl ether polyols are in particular glycidyl ether, for example, without limitation, 1,4-butanediol diglycidylether (BDDGE), polyalkylene glycol diglycidyl ether, trimethylolpropane triglycidyl ether, bisphenol-A-diglycidyl ether (BADGE), novolac-based epoxides and epoxidized polybutadienes or fatty acid esters.

In various embodiments, the alkenyl ether polyol of formula (I) can be obtained by reacting an alkenyl ether of formula (II) with an epoxide of formula (III) or (IIIa).

In place of an epoxide, the compounds, which are reacted with the compounds (alkenyl ether compounds) that are reactive to epoxides, may also be cyclic carbonates or derivatives thereof. Cyclic carbonate compounds are subject to a reactivity, of a nature similar to that of the epoxides, to the compounds acting as reaction partners, which nucleophilically add both epoxides and cyclic carbonate compounds by ring opening and “regeneration” of an alcoholic functional group to, in the case of an epoxide, methylene of the epoxide ring, or, in the case of a cyclic carbonate, carbonyl carbon atom, as a result of which, depending on the reactive, nucleophilic group, an O—C—, N—C, S—C, or O—/N—/S—C(═O)O bond is formed.

In preferred embodiments, the cyclic carbonates, which, in the described method for producing alkenyl ether polyols, can be reacted with an alkenyl ether, in particular an alkenyl ether of formula (II), are cyclocarbonates of formula (IV) or (IVa)

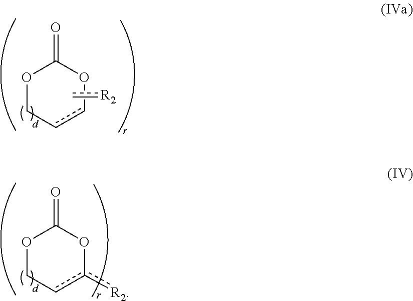

In compounds of formula (IV) and (IVa), R₂ is defined as for formulae (I), (III) and (IIIa). In particular, R₂ is a C₁₋₁₀ hydroxyalkyl. In other embodiments, R₂ may be ═CH₂.
[symbol] is a single or double bond, preferably a single bond. It is self-evident that, when the ring contains a double bond, R₂ is not bonded via an exo double bond but rather via a single bond and vice versa.

d is 0, 1, 2, 3, 4 or 5, preferably 0 or 1, particularly preferably 0, and r is an integer of from 1 to 10, preferably 1 or 2 and more particularly preferably 1.

When d is 1, i.e. the cyclocarbonate is a 1,3-dioxane-2-one, R₂ may be in the 4- or 5-position, but is preferably in the 5-position.

Exemplary cyclic carbonates include, without being limited to, 1,3-dioxolane-2-one, 4,5-dehydro-1,3-dioxolane-2-one, 4-methylene-1,3-dioxolane-2-one, and 1,3-dioxane-2-one, which are substituted by R₂ in the 4- or 5-position.

In various embodiments of the described method for producing alkenyl ether polyols, cyclic carbonates that are derivatives of the carbonates of formulae (IV) and (IVa) are used. Exemplary derivatives include those that are substituted at the ring methylene groups, in particular those that do not carry the R₂ group, for example by organic groups, in particular linear or branched, substituted or unsubstituted alkyl or alkenyl groups having up to 20 carbon atoms, in particular ═CH₂ and —CH═CH₂, or linear or branched, substituted or unsubstituted heteroalkyl- or heteroalkenyl groups having up to 20 carbon atoms and at least one oxygen or nitrogen atom, or functional group, for example —OH or —COOH. Examples of such derivatives include, for example, 4-methylene-1,3-dioxolane-2-one, which carries the R₂ group at the 5-position, or di-(trimethylolpropane) dicarbonate, the R₂ group in the 5-position being a methylene trimethylol monocarbonate group.

In various embodiments in which the R₂ group is bonded via a single bond, the ring carbon atom that carries the R₂ group can be substituted by another substituent, which is defined as per the above-mentioned substituent for the other ring methylene group.

Further derivatives are those in which one or both of the ring oxygen atoms are replaced by sulfur atoms and those in which alternatively or additionally the carbonyl oxygen atom is replaced by a sulfur atom. A particularly preferred derivative is the 1,3-oxathiolane-2-thione.

In various embodiments, the cyclic carbonate is 4-methylene-1,3-dioxolane-2-one, which carries the R₂ group at the 5-position. If a cyclic carbonate of this kind is reacted with an alkenyl ether that carries an amino group as the reactive group, a compound of formula (Ia) may form:

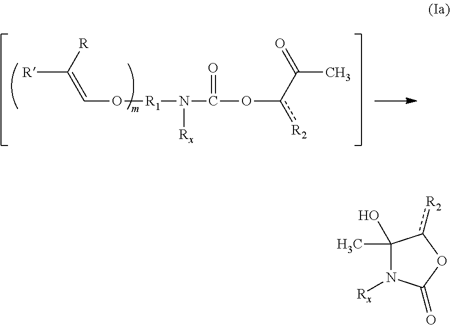

In this compound, m, R₁, R, R′, R₂ and Rₓ are as defined above for the compounds of formula (I)-(IV). These compounds of formula (Ia) do not contain any alkenyl ether groups and therefore, although they can be used as polyols for producing polyurethanes or polyesters, they can only do this in combination with additional polyols that contain alkenyl ether groups. Such compounds of formula (Ia) are therefore not preferred according to the invention.

In the reaction of the above-described cyclocarbonates and the derivatives thereof of formulae (IV) and (IVa) with a compound of formula (II), in various embodiments, in the compounds of formula (II) (i) X₁ is —NH₂ or a derivative thereof, and in the compound of formula (IV) or (IVa) r is 1; or (ii) X₁ is —OH or a derivative thereof, and in the compound of formula (IV) or (IVa) r is 2.

In various embodiments of the invention, alkenyl ether polyols that contain at least one urethane group are preferred. These can be obtained by reacting the above-defined alkenyl ethers that carry amino groups as the reactive groups with the described cyclic carbonates.

In other embodiments, the alkenyl ether polyol can be obtained by reacting the compounds listed in route B). In this case the alkenyl ether polyol is produced by reacting an alkenyl ether, containing at least one alkenyl ether group and at least one functional group selected from (i) epoxide groups and (ii) cyclic carbonate groups or derivatives thereof, with an alcohol, thiol, a carboxylic acid, or an amine or derivatives thereof.

In various embodiments of this method, the alkenyl ether polyol is an alkenyl ether polyol of formula (V)

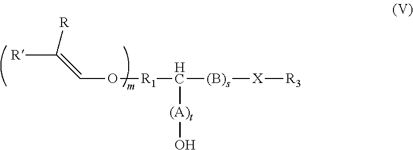

In the compounds of formula (V), R₁ is as defined above for the compounds of formula (I).

R₃ is an organic group, optionally having at least one —OH group and/or 1 to 1,000 carbon atoms, in particular an (optionally divalent or polyvalent) linear or branched, substituted or unsubstituted alkyl having 1 to 50, preferably 1 to 20 carbon atoms or an (optionally divalent or polyvalent) linear or branched, substituted or unsubstituted heteroalkyl having 1 to 50, preferably 1 to 20 carbon atoms and at least one oxygen or nitrogen atom. However, R₂ may also be a high-molecular group such as a polyalkylene glycol group. A (poly)alkylene glycol group of this kind may have the formula —O—[CHRₐCH₂O]_{b}-R_{b}, for example, where Rₐ is H or a C₁₋₄ alkyl group, R_{b} is —H or an organic group or

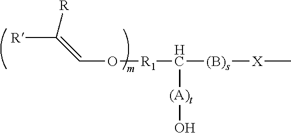

and b is from 1 to 100.

In the compounds of formula (V), X is O, S, OC(═O), OC(═O)O, OC(═O)OC(═O), NR_{z}, NR_{z}C(═O)O, NR_{z}C(═O)NR_{z} or OC(═O)NR_{z}. In a preferred embodiment, X is O, OC(═O)O, NR_{z} or OC(═O)NR_{z}.

Each R and R′ is selected independently from H, C₁₋₂₀ alkyl and C₂₋₂₀ alkenyl, in particular one of R and R′ being H and the other being C₁₋₄ alkyl or both R and R′ being H. Particularly preferably, R is H and R′ is H or —CH₃.

Each A and B is independently selected from CR″R′″, where R″ and R′″ are independently selected from H, a functional group, for example —OH, —NH₂, —NO₂, —CN, —OCN, —SCN, —NCO, —NCS, —SH, —SO₃H or —SO₂H, and an organic group. In particular, R″ and R″′ are independently H or C₁₋₂₀ alkyl. However, R″ and R′″ together or together with the carbon atom to which they are bonded may also form an organic group, including cyclic groups, or a functional group. Examples of groups of this kind are ═CH₂, ═CH-alkyl or ═C(alkyl)₂, ═O, ═S, —(CH₂)ₐₐ- where aa=3 to 5 or derivatives thereof, in which one or more methylene groups are replaced by heteroatoms such as N, O or S. However, two of R″ and R′″, which are bonded to adjacent carbon atoms, may also together form a bond. As a result, a double bond is formed between the two adjacent carbon atoms (i.e. —C(R″)═C(R″)—).

In the compounds of formula (V), m is an integer of from 1 to 10, preferably 1 or 2, particularly preferably 1. i.e., the compounds preferably carry only one or two alkenyl ether group(s).

s and t are each 0 or an integer of from 1 to 10. In this case, they meet the condition s+t=1 or more, in particular 1 or 2. It is particularly preferred that s or t is 1 and the other is 0.

R_{z} is H, an organic group or

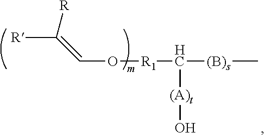

So that the alkyl ether polyol of formula (V) meets the condition that it carries at least two hydroxyl groups, when R_{z} is not

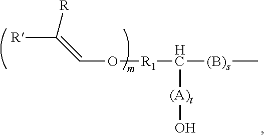

R₃ is substituted by at least one substituent that is selected from —OH and

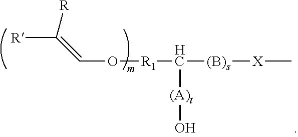

In other preferred embodiments, the method is characterized in that the alkenyl ether, which contains at least one alkenyl ether group and at least one functional group selected from (i) epoxide groups and (ii) cyclic carbonate groups or derivatives thereof, is an alkenyl ether of formula (VI) or (VII)

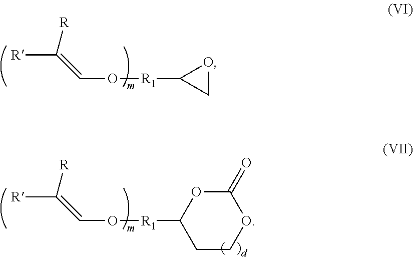

In the compounds of formula (VI) or (VII), R₁, R, R′ and m are as defined above for the compounds of formulae (I) and (II).

d is as defined above for the formulae (IV) and (IVa), i.e. d is 0, 1, 2, 3, 4 or 5, preferably 0 or 1, particularly preferably 0.

In particularly preferred embodiments, R₁ is —C₁₋₁₀-alkylenyl-O—CH₂— in the alkenyl ethers of formula (VI) or (VII).

The alkenyl ethers of formula (VI) carrying epoxy groups may be substituted by R₁₁-R₁₃ at the epoxy group, i.e. the methylene groups of the oxirane ring, as shown in formula (IIIa).

In various embodiments, the alkenyl ethers of formula (VIII) are substituted at the cyclocarbonate ring or the cyclocarbonate ring is replaced by a corresponding derivative. Suitable substituted cyclocarbonates and derivatives thereof are those that have been described above in connection with formula (IV) and (IVa). In particular, the cyclocarbonate group is preferably a 1,3-dioxolane-2-one group or 1,3-dioxane-2-one group, which can optionally be substituted, for example with a methylene group.

Suitable compounds of formula (VI) include, without being limited to, vinyl glycidyl ether and 4-glycidyl butyl vinyl ether (GBVE), it being possible to obtain the latter by reacting 4-hydroxybutyl vinyl ether with epichlorohydrin.

Suitable compounds of formula (VII) include, without being limited to, 4-(ethenyloxymethyl)-1,3-dioxolane-2-one, which can be obtained for example by interesterifying glycerol carbonate with ethyl vinyl ether or 4-glycerol carbonate(4-butyl vinyl ether)ether (GCBVE), which can be obtained by epoxidizing hydroxybutyl vinyl ether (HBVE) and subsequent CO₂ insertion.

In different embodiments, the alkenyl ether, which contains at least one alkenyl ether group and at least one functional group selected from (i) epoxide groups and (ii) cyclic carbonate groups or derivatives thereof, in particular an alkenyl ether of formula (VI) or (VII), is reacted with an alcohol or amine. The alcohol may be a diol or polyol or a corresponding alcoholate. In particular, the alcohol may be a polyalkylene glycol of formula HO—[CHRₐCH₂O]_{b}—H, where Rₐ is H or a C₁₋₄ alkyl group and b is from 1 to 100, in particular 1 to 10.

Route B is thus an alternative embodiment in which the epoxide or the cyclic carbonate compounds (for example ethylene carbonate or trimethylene carbonate compounds) comprise at least one or more alkenyl ether groups. The reaction of these epoxide or cyclic carbonate compounds with compounds that are reactive to epoxides or to compounds (cyclic carbonates) that act in a chemically similar manner in the context of the present invention, in particular those that carry —OH, —COOH, —SH, —NH₂ and similar groups or the derivatives thereof (for example correspondingly functionalized, preferably correspondingly polyfunctionalized linear or branched, saturated or partially unsaturated, additionally substituted or unsubstituted, cyclic or linear (hetero)alkyls and (hetero)aryls) results in the desired alkenyl ether polyols.

Examples of compounds that comprise at least one of the groups —OH, —COOH, —SH, —NH₂ and derivatized forms thereof but do not comprise any alkenyl ether groups are, for example, without limitation, glycols, polyglycols, amino acids, polyols and di- and polyamines, for example glycine, glycerin, hexamethylenediamine, 1,4-butanediol and 1,6-hexanediol.

In various embodiments, alkenyl ether polyols comprising at least one urethane group and that can be obtained by reacting an alkenyl ether with cyclic carbonate groups and an amine are preferred.

The alkenyl ether polyols that can be produced or obtained by the described method are, for example, compounds of formulae (I), (Ia) and (V), as defined above.

In various embodiments of the alkenyl ether polyols of formula (I):
(1) m=1; R and R′ are H or R is H and R′ is methyl; R₁ is C₁₋₁₀ alkylenyl, in particular C₁₋₆ alkylenyl, X is O, A and B are CH₂, n and o are 1 or 0 and p is 0, where n+o=1, and R₂ is an organic group that is substituted by —OH or carries another group of formula

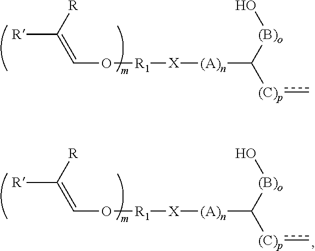

where R₁, m, R, R′, A, B, C, n, o and p are as defined above; or
(2) m=1; R and R′ are H or R is H and R′ is methyl; R₁ is C₁₋₁₀ alkylenyl, in particular C₁₋₆ alkylenyl, X is NRₓ, A and B are CH₂, n and o are 1 or 0 and p is 0, where n+o=1 Rₓ is H or

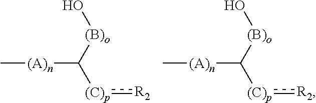

where A, B, C, n, o and p are as defined above; and R₂ is an organic group as defined above that, when Rₓ is H, is substituted by —OH or carries another group of formula

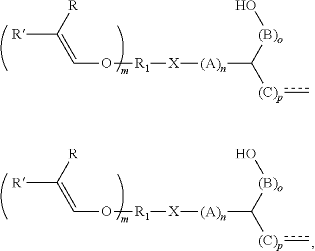

where R₁, m, R, R′, A, B, C, n, o and p are as defined above; or
(3) m=1; R and R′ are H or R is H and R′ is methyl; R₁ is C₁₋₁₀ alkylenyl, in particular C₁₋₆ alkylenyl, X is OC(═O)O, A and B are CH₂, n and o are 1 or 0 and p is 0, where n+o=1, and R₂ is an organic group that is substituted by —OH or carries another group of formula

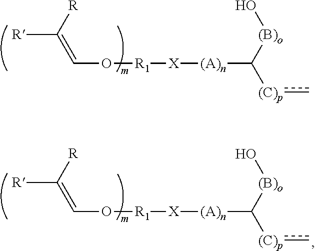

where R₁, m, R, R′, A, B, C, n, o and p are as defined above; or
(4) m=1; R and R′ are H or R is H and R′ is methyl; R₁ is C₁₋₁₀ alkylenyl, in particular C₁₋₆ alkylenyl, X is NRₓC(═O)O, A and B are CH₂, n and o are 1 or 0 and p is 0, where n+o=1, Rₓ is H or

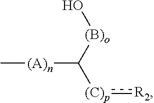

where A, B, C, n, o and p are as defined above; and R₂ is an organic group as defined above that, when Rₓ is H, is substituted by —OH or carries another group of formula

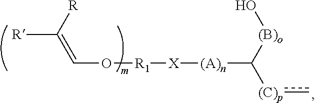

where R₁, m, R, R′, A, B, C, n, o and p are as defined above.

In the above-mentioned embodiments, R₂ is preferably bonded via a single bond and may be a heteroalkyl group, in particular an alkyl ether group having 2 to 10 carbon atoms, for example. Groups of formula —CH₂—O—(CH₂)₄—O—CH₂— (in the event that R₂ carries two alkenyl ether groups of the above formula) or —CH₂—O—CH(CH₃)₂ are suitable, for example.

In various embodiments of the alkenyl ether polyols of formula (V):
(1) m=1; R and R′ are H or R is H and R′ is methyl; R₁ is —(CH₂)₁₋₁₀—O—CH₂—, in particular —(CH₂)₁₋₆—O—CH₂—, X is O, A and B are CH₂, s and t are 1 or 0, where s+t=1, and R₃ is an organic group that is substituted by —OH or carries another group of formula

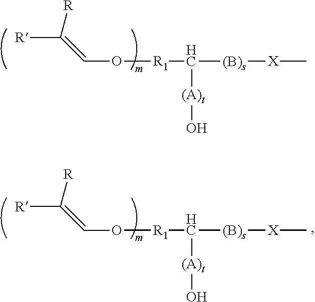

where R₁, m, R, R′, A, B, s and t are as defined above; or
(2) m=1; R and R′ are H or R is H and R′ is methyl; R₁ is —(CH₂)₁₋₁₀—O—CH₂—, in particular —(CH₂)₁₋₆—O—CH₂—, X is NR_{z}, A and B are CH₂, s and t are 1 or 0, where s+t=1, R_{z} is H or

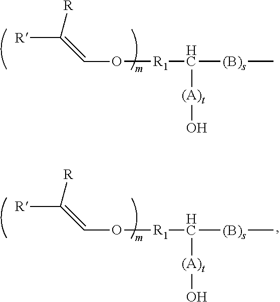

where A, B, m, s and t are as defined above; and R₃ is an organic group as defined above that, when R_{z} is H, is substituted by —OH or carries another group of formula

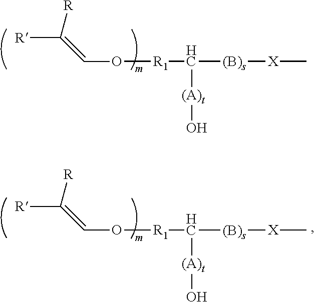

where R₁, m, R, R′, A, B, s and t are as defined above; or
(3) m=1; R and R′ are H or R is H and R′ is methyl; R₁ is —(CH₂)₁₋₁₀—O—CH₂—, in particular —(CH₂)₁₋₆—O—CH₂—, X is OC(═O)O, A and B are CH₂, s and t are 1 or 0, where s+t=1, and R₃ is an organic group that is substituted by —OH or carries another group of formula

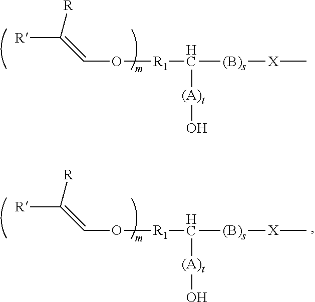

where R₁, m, R, R′, A, B, s and t are as defined above; or
(4) m=1; R and R′ are H or R is H and R′ is methyl; R₁ is —(CH₂)₁₋₁₀—O—CH₂—, in particular —(CH₂)₁₋₆—O—CH₂—, X is OC(═O)NR_{z}, A and B are CH₂, s and t are 1 or 0, where s+t=1, and R_{z} is H or

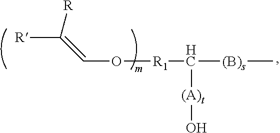

where A, B, m, s and t are as defined above; and R₃ is an organic group as defined above that is substituted by —OH or carries another group of formula

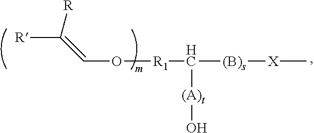

where R₁, m, R, R′, A, B, s and t are as defined above.

In the previously mentioned embodiments of the compounds of formula (V), R₃ is, for example, a heteroalkyl group, in particular a (poly)alkylene glycol, such as in particular polypropylene glycol, or a C₁₋₁₀ alkyl or alkylenyl group.

The individual stages of the described method for producing the alkenyl ether polyols of formula (I) or (V) can be carried out according to the methods that are conventional for such reactions. For this purpose, the reaction partners, optionally after activation (for example producing alcoholates by reaction with sodium), are brought into contact with one another and optionally reacted in a protective gas atmosphere and under temperature control.

The above-described alkenyl ether polyols are then used in the method according to the invention for the synthesis of polymers, in particular polyhydroxyurethanes, by reaction with thiol compounds via a thiol-ene polyaddition reaction. Alternatively, prepolymers that contain these monomer units may also be used in place of the alkenyl ether polyols. Examples of such prepolymers are, for example, polyurethanes and polyesters, which can be obtained by reacting at least one of the described alkenyl ether polyols or a mixture of polyols, which contains at least one of the described alkenyl ether polyols, with polyisocyanates or polycarboxylic acids. Depending on which component is used in excess, OH— or NCO-terminated polyurethanes comprising alkenyl ether side chains or OH— or COOH-terminated polyesters comprising alkenyl ether side chains can thus be obtained. These can then be reacted with the polythiols according to the invention to form polymers.

Alternatively, alkenyl group-containing compounds can be crosslinked (cured) by reaction with polythiol compounds. The alkenyl group-containing compounds may be alkenyl ether polyols as defined above or polymers that contain said alkenyl ether polyols as monomer units. The polymers may be, for example, polyurethanes or polyesters that can be obtained by reacting at least one of the described alkenyl ether polyols or a mixture of polyols, which contains at least one of the described alkenyl ether polyols, with polyisocyanates or polycarboxylic acids.

In this case, the thiol compounds used are organic compounds that comprise at least two thiol groups, for example dimercapto compounds, preferably optionally substituted dimercapto alkanes. Exemplary compounds are those of formula (VIII)

(HS)ᵤ—R₄—SH (VIII)

where
R₄ is an at least divalent organic group, in particular an at least divalent linear or branched, substituted or unsubstituted alkyl having 1 to 20 carbon atoms or linear or branched, substituted or unsubstituted heteroalkyl having 1 to 20 carbon atoms and at least one oxygen or nitrogen atom; and
u is an integer of from 1 to 10, preferably 1 to 5.

Examples of suitable polythiol compounds are, for example, 1,2-ethanedithiol, 1,8-dimercapto-3,6-dioxaoctanes (DMDO), glycoldi(3-mercaptopropionate) (GDMP), trimethylolpropane tri(3-mercaptopropionate) (TMPMP), pentaerythritol tetra(3-mercaptopropionate) (PETMP), dipentaerythritol hexakis(3-mercaptopropionate) (Di-PETMP), ditrimethyloipropane tetra(3-mercaptopropionate) (Di-TMPMP), glycol dimercaptoacetate (GDMA), trimethylolpropane trimercaptoacetate (TMPMA), pentaerythritol tetramercaptoacetate (PETMA), ethoxylated TMPMP (ETTMP), propylene glycol(3-mercaptopropionate) (PPGMP), 2,3-di((2-mercaptoethyl)thio)-1-propanethiol (DMPT), dimercaptodiethylsulfide (DMDS), tris[2-(3-mercaptopropionyloxy)ethyl]isocyanurate (TEMPIC), or mercaptoacetates and mercaptopropionates of various alkoxylated polyols. Polythiols of this kind are commercially available from Bruno Bock GmbH & Co. KG (Marschacht, DE).

In the method according to the invention for producing polymers, in particular linear polymers, dithiols are preferably used. In the method according to the invention for crosslinking polymers, preferably dithiols, more preferably higher-valent thiols such as trithiols or tetrathiols are used.

In various embodiments of the method according to the invention, the reaction partners, i.e. the alkenyl ether polyols/alkenyl ether group-containing polymers and the thiols, are brought to reaction by exposure to electromagnetic radiation in the presence of a photoinitiator, for example 2,2′-azobis(2,4-dimethylvaleronitrile). The reaction mechanism is a radical-mediated polyaddition (thiol-ene). The reaction can take place in solution in a suitable organic solvent, for example THF, since in this case the reaction control can be simpler. In addition, as well as corresponding photoinitiators, in principle initiatiors for radical reactions, which initiators can be activated by temperature and/or redox reactions, are also suitable. Examples thereof are azo initiators such as AIBN, organic peroxide compounds, redox pairs (SFS, H₂O₂, tert-butyl peroxide, acscorbic acid) and all other systems known to a person skilled in the art for this purpose.

The use of photoinitiator systems is preferred, generally all photoinitiators known in the prior art being suitable. These may optionally also be used in combination with known sensitizers or also other radical initiators.

The electromagnetic radiation may be in particular visible light or UV light and is selected depending on the photoinitiators used.

The initiation of the polymer synthesis by radiation is a significant use advantage over conventional polymerization, in particular for crosslinking systems. The corresponding formulations, which contain the reaction partners, represent a latently reactive 1K system, the curing of which is actively triggered only upon irradiation.

In the methods, the alkenyl ether polyols or the (pre)polymers that contain the alkenyl ether polyols as monomer units and thiols are used in various embodiments in such amounts that the molar ratio of alkenyl ether groups to thiol groups is in the range of from 0.1 to 10, preferably in the range of from 0.8 to 2.0.

Finally, the invention also relates to the polymers that can be produced by means of the method described herein, in particular the polyhydroxyurethanes and crosslinked polymers. The polyhydroxyurethanes may also be provided in the form of water-based dispersions (PUD).

The invention further includes compositions that contain the polymers described herein, in particular adhesives, sealants and coating agents.

The invention also relates to the use of the polymers described herein as a component of adhesive, sealant and coating agent compositions. Compositions of this kind may further contain all conventional additives and auxiliaries that are known to a person skilled in the art.

All embodiments disclosed herein in connection with the methods according to the invention for producing polymers or the methods for crosslinking alkenyl ether group-containing polymers with thiol compounds can also be transferred to the described polymers as such, and to the use thereof and methods for the use thereof, and vice versa.

The invention is further exemplified in the following by reference to examples, which should not be understood to be limiting.

### EXAMPLES

### Materials Used

4-Hydroxybutyl vinyl ether (HBVE) (BASF, 99% stabilized using 0.01% KOH), epichlorohydrin (ECH, Solvay, 99.8%), tetrabutylammonium bromide (TBAB, Merck, 99%), tetraethylammonium bromide (TEAB, Merck, 99%), 1,4-butanediol diglycidyl ether (BDDGE, Sigma-Aldrich, 95%), di(trimethylolpropane) (di-TMP, Sigma-Aldrich, 97%), ethyl chloroformiate (Alfa Aesar, 97%), triethylamine (Acros Organics, 99%), ethylene glycol-bis(aminopropyl)ether (EGBAPE, Huntsman, Jeffamin EDR-176), 3-aminopropyl vinyl ether (APVE, BASF, 99.7%), hexamethylene diisocyanate (HDI, Acros Organics, 99%), dimethyltin dineodecanoate (Momentive, Fomrez catalyst UL-28), methanol (VWR Chemicals), 10-[1,1′-biphenyl]-4-yl-2-(1-methylethyl)-9-oxo-9H-thioxanthenium hexafluorophosphate (Omnicat 550, IGM), dimercapto-1,8-dioxa-3,6-octane (DMDO, Arkema), pentaerythritol tetra(3-mercaptopropionate) (Bruno Bock, Thiocure PETMP, 95%) and 2,2′azobis(2,4-dimethylvaleronitrile) (Wako V65) were used as obtained.

### Example 1

### Synthesis of Di-Trimethylolpropane Dicarbonate (di-TMPDC)

Di-TMPDC was synthesized according to Yang et al. (Polymer 2013, 54, (11), 2668-2675). For this purpose, 37.55 g (0.15 mol) di-TMP were dissolved in 1 L dry THF and cooled to −10° C. 97.67 g (0.9 mol) ethyl chloroformate were added dropwise at this temperature. Triethylamine was then added under the same conditions before the mixture was stirred overnight without cooling. The mixture was filtered off and washed with water. The organic solution was concentrated under reduced pressure, the product was precipitated in diethyl ether and recrystallized from THF in order to give a white solid. Yield: 76%. Elemental analysis: C, 55.69; H, 7.37; O, 36.94 (calculated: C, 55.62; H, 7.33; O, 37.05 for C₁₄H₂₂O₇). MS (CI): m/z=320.1 [M+NH4]⁺(calculated: 302.2 for C₁₄H₂₂O₇NH₄). ¹H NMR (400 MHz, CDCl₃, 298 K) δ (ppm): 0.95 (t, 6H, CH3), 1.49 (q, 4H, CH₂—CH₃), 3.49 (s, 4H, CH₂—O), 4.22 (dd, 8H, CH₂ cyclic carbonate).

### Example 2

### Synthesis of the Vinyl Ether Polyol

9.10 g (30 mmol) di-TMPDC from Example 1 and 6.09 g (60 mmol) APVE were mixed and heated to 80° C. for 22 h in a nitrogen atmosphere. The conversion was monitored by IR spectroscopy using the C═O stretching vibration of the five-membered carbonate and the urethane at 1780 cm⁻¹ and 1690 cm⁻¹, respectively.

### Example 3

### Synthesis of the Linear Polyhydroxyurethane

4.28 (8.5 mmol) of the vinyl ether polyol from Example 2, 1.55 g (8.5 mmol) 1,8-dimercapto-3,6-dioxaoctane (DMDO) and 0.058 g (1 wt. %) 2,2′-azobis(2,4-dimethylvaleronitrile) was placed in a 100 ml three-neck round-bottom flask, dissolved in 50 ml THF and purged with nitrogen. A Loctite 97034 light source equipped with a UVC 97327 optical waveguide was connected to the central neck and the reaction was started by UV radiation for 900 seconds at room temperature while stirring at 500 rpm. THF was removed under reduced pressure and IR spectroscopy indicated the consumption of vinyl ether and functional thiol groups.

### Example 4

### Synthesis of the Crosslinked Polyhydroxyurethane

1.01 g (2 mmol) of the vinyl ether polyol from Example 2, 0.43 g (1 mmol) PETMP and 7.3 mg g (0.5 wt. %) 2,2′-azobis(2,4-dimethylvaleronitrile) were mixed and the sample was cured in a rheometer. Rheological and NIR spectroscopic analyses of the UV-induced curing reaction were carried out using an Anton Paar MCR 302 rheometer coupled to a Bruker MPA FT-NIR spectrometer and an Omnicure S 2000 SC light source. The instrument was constructed in a plate-plate geometry using a quartz glass base plate and a disposable aluminum cover plate having a diameter of 25 mm at an initial gap distance of 100 μm. A normal force of 0 was used to prevent stress due to contraction or expansion of the sample. The measurement was carried out at 75° C. in an instrumental atmosphere of air (H₂O: 1.1 mg/m³). The data were initially recorded every 5 s at a sinusoidal voltage of 10% and a frequency of 10 Hz. The sample was then irradiated for 30 s at an intensity of 189 mW cm⁻² UVA-C. This intensity was determined on the surface of the quartz plate using a spectral radiometer (Opsytec Dr. Gobel). During the irradiation, mechanical data were recorded at a rate of 1 s⁻¹ and the sinusoidal voltage was raised linearly to 0.5% within 210 s and kept constant for another 360 s. NIR spectra were recorded at a rate of approximately 2 s⁻¹ at a resolution of 16 cm⁻¹. The reaction of the vinyl ether double bond was followed by the observation of the characteristic absorption of the C—H stretching overtone at 6200 cm⁻¹.

1. A method for producing a polymer, comprising:
providing at least one alkenyl ether polyol containing at least one alkenyl ether group and at least two hydroxyl groups (—OH), or providing a prepolymer which contains at least one alkenyl ether polyol containing at least one alkenyl ether group and at least two hydroxyl groups (—OH) as a monomer unit;
providing a compound that contains at least two thiol groups; and
reacting the at least one alkenyl ether polyol or reacting the prepolymer with the compound that contains at least two thiol groups.

2. The method of claim 1 wherein the polymer is a polyhydroxyurethane.

3. A method for crosslinking a first compound or crosslinking a polymer, comprising:
providing the first compound wherein the first compound contains at least one alkenyl ether group and at least two hydroxyl groups (—OH), or the polymer wherein the polymer contains at least one alkenyl ether polyol as a monomer unit;
providing a second compound that contains at least two thiol groups; and
reacting the first compound and the second compound.

4. The method of claim 3 wherein the first compound that contains at least one alkenyl ether group is an alkenyl ether polyol.

5. The method of claim 3 wherein at least one alkenyl ether group is a 1-alkenyl ether group.

6. The method according to claim 1, wherein the alkenyl ether polyol is obtained by:
A) reacting an alkenyl ether, containing at least one alkenyl ether group and at least one functional group selected from —OH, —COOH, —SH, —NH₂ and derivatives thereof, with (i) an epoxide or (ii) a cyclic carbonate or derivative thereof; or
B) reacting an alkenyl ether, containing at least one alkenyl ether group and at least one functional group selected from (i) epoxide groups and (ii) cyclic carbonate groups or derivatives thereof, with an alcohol, thiol, a carboxylic acid, or an amine or derivatives thereof.

7. The method according to claim 6, wherein the alkenyl ether polyol is obtained by reacting an alkenyl ether, containing at least one alkenyl ether group and at least one functional group selected from —OH, —COOH, —SH, —NH₂ and derivatives thereof, with (i) an epoxide or (ii) a cyclic carbonate or derivative thereof, and the alkenyl ether polyol is an alkenyl ether polyol of formula (I) 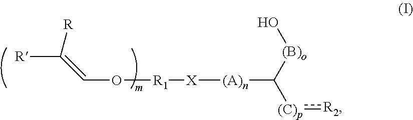
where
R₁ is an at least divalent organic group, or an at least divalent linear or branched, substituted or unsubstituted alkyl having 1 to 20 carbon atoms, or a linear or branched, substituted or unsubstituted heteroalkyl having 1 to 20 carbon atoms and at least one oxygen or nitrogen atom,
R₂ is an organic group, optionally having at least one —OH group and/or 1 to 1,000 carbon atoms, or an optionally divalent or polyvalent, linear or branched, substituted or unsubstituted alkyl having 1 to 20 carbon atoms, or a linear or branched, substituted or unsubstituted heteroalkyl having 1 to 20 carbon atoms and at least one oxygen or nitrogen atom,
X is O, S, C(═O)O, OC(═O)O, C(═O)OC(═O)O, NRₓ, NRₓC(═O)O, NRₓC(═O)NRₓ or OC(═O)NRₓ,
each R and R′ is selected independently from H, C₁₋₂₀ alkyl and C₂₋₂₀ alkenyl, or one of R and R′ is H and the other is C₁₋₄ alkyl or both R and R′ are H,
each A, B and C is selected independently from CR″R′″,
R′ and R′″ are selected independently from H, a functional group, an organic group, and C₁₋₂₀ alkyl, or R″ and R′″ together or with the carbon atom to which they are bonded are an organic group, or two of R″ and R′″ that are bonded to adjacent carbon atoms together form a bond in order to form a double bond between the adjacent carbon atoms, [symbol]
is a single or double bond, and, when it is a double bond, the carbon atom that is bonded to R₂ carries only one substituent R″ or R″′,
m is an integer of from 1 to 10,
n, p, and o are each 0 or an integer of from 1 to 10, where n+p+o=1 or more, and
Rₓ is H, an organic group or 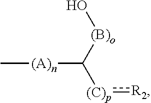
and, when Rₓ is not 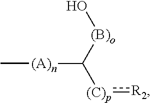
R₂ comprises at least one substituent that is selected from —OH and

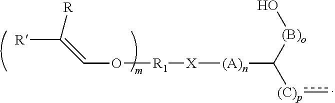

8. The method according to claim 6, in which the alkenyl ether polyol is obtained by reacting an alkenyl ether, containing at least one alkenyl ether group and at least one functional group selected from (i) epoxide groups and (ii) cyclic carbonate groups or derivatives thereof, with an alcohol, thiol, a carboxylic acid, or an amine or derivatives thereof, wherein the alkenyl ether polyol is of formula (V) 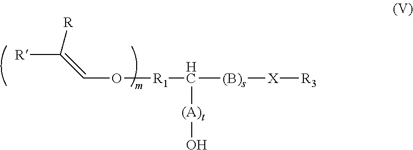
where
R₁ is an at least divalent organic group, or an at least divalent linear or branched, substituted or unsubstituted alkyl having 1 to 20 carbon atoms or, an at least divalent linear or branched, substituted or unsubstituted heteroalkyl having 1 to 20 carbon atoms and at least one oxygen or nitrogen atom,
R₃ is an organic group, optionally having 1 to 1,000 carbon atoms, or a linear or branched, substituted or unsubstituted alkyl having 1 to 20 carbon atoms, or a linear or branched, substituted or unsubstituted heteroalkyl having 1 to 20 carbon atoms and at least one oxygen or nitrogen atom, or a (poly)alkylene glycol of the formula
—O—[CHRₐCH₂O]_{b}—R_{b},
where Rₐ is H or a C₁₋₄ alkyl group,
R_{b} is H or 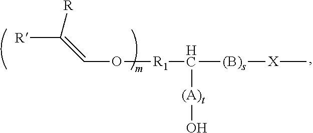
and b is from 1 to 100;
each X is O, S, OC(═O), OC(═O)O, OC(═O)OC(═O), NR_{z}, NR_{z}C(═O)O, NR_{z}C(═O)NR_{z} or OC(═O)NR_{z},
each R and R′ is selected independently from H, C₁₋₂₀ alkyl and C₂₋₂₀ alkenyl, or one of R and R′ is H and the other is C₁₋₄ alkyl or both R and R′ are H,
each A and B is independently selected from CR″R′″,
R″ and R′″ are selected independently from H, a functional group, an organic group, or C₁₋₂₀ alkyl, or R″ and R′″ together or with the carbon atom to which they are bonded are an organic group, or two of R″ and R′″ that are bonded to adjacent carbon atoms together form a bond in order to form a double bond between the adjacent carbon atoms,
m is an integer of from 1 to 10, preferably 1,
s and t are each 0 or an integer of from 1 to 10, where s+t=1 or more, and
R_{z} is H, an organic group or 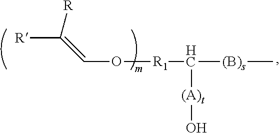
and, when R_{z} is not 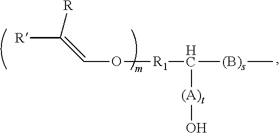
R₃ comprises at least one substituent that is selected from —OH and

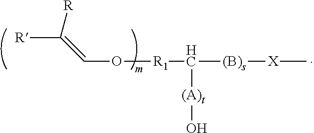

9. The method according to claim 1, wherein the compound that contains at least two thiol groups is a dimercapto compound or an an optionally substituted dimercapto alkane.

10. The method according to claim 9, wherein the compound that contains at least two thiol groups is a compound of formula (VI)
(HS)ᵤ—R₄—SH (VI)
where
R₄ is an at least divalent organic group, or an at least divalent linear or branched, substituted or unsubstituted alkyl having 1 to 20 carbon atoms or an at least divalent linear or branched, substituted or unsubstituted heteroalkyl having 1 to 20 carbon atoms and at least one oxygen or nitrogen atom; and
u is an integer of from 1 to 10.

11. The method according to claim 1, wherein the molar ratio of alkenyl ether groups to thiol groups is in the range of from 0.1 to 10.

12. A hydroxyl group-containing polymer or crosslinked compound obtained using the method according to claim 1.

13. The hydroxyl group-containing polymer according to claim 9, wherein the polymer is a polyhydroxyurethane having a number average molecular weight Mₙ of at least 1,000 g/mol.

14. A composition comprising a hydroxyl group-containing polymer according to claim 9.
